(19) United States
(12) Patent Application Publication
(10) Pub. No.: US 2025/0193540 A1
(43) Pub. Date: Jun. 12, 2025

(54) LOW-COMPLEXITY MOTION-SENSITIVE ELECTRONIC DEVICE

(71) Applicant: XEG Ventures LLC, Wilmington, DE (US)

(72) Inventor: Kilton Patrick Hopkins, Berkeley, CA (US)

(73) Assignee: XEG Ventures LLC, Willmington, DE (US)

(21) Appl. No.: 18/970,926

(22) Filed: Dec. 6, 2024

Related U.S. Application Data
(60) Provisional application No. 63/607,532, filed on Dec. 7, 2023.

(51) Int. Cl. H04N 25/40; H04N 23/55; H04N 25/47

(52) U.S. Cl. CPC H04N 25/41; H04N 23/55; H04N 25/47

(57) ABSTRACT

An electronic device may include a lens that conveys and focuses input electromagnetic waves. Moreover, the electronic device may include an optical component, optically coupled to the lens, that divides the input electromagnetic waves into a first subset of the input electromagnetic waves and a second subset of the input electromagnetic waves. Furthermore, the electronic device may include a first image sensor, optically coupled to the optical component, that receives the first subset of the input electromagnetic waves. Additionally, the electronic device may include a second image sensor, optically coupled to the optical component, that receives the second subset of the input electromagnetic waves, where the first image sensor has a lower resolution than the second image sensor, the first image sensor has a higher sampling rate than the second image sensor, and the first image sensor detects motion of one or more first objects.

### CROSS REFERENCE TO RELATED APPLICATIONS

This application claims priority under 35 U.S.C. 119 (e) to U.S. Provisional Application Ser. No. 63/607,532, entitled “Low-Complexity Motion-Sensitive Electronic device, by Kilton Patrick Hopkins, filed on Dec. 7, 2023, the contents of which are herein incorporated by reference.

### FIELD

The described embodiments relate to image sensors. Notably, the described embodiments relate to an electronic device with at least two image sensors, including a first image sensor and a second image sensor having a lower resolution and a higher sampling rate than the first image sensor.

### BACKGROUND

The cost and complexity of existing image sensors typically increases significantly as the resolution and the sampling rate is increased. Consequently, existing image sensors usually are designed to tradeoff their resolution and sampling rate in an attempt to reduce cost and complexity. However, these tradeoffs often limit the performance of existing image sensors. For example, the ability of existing high-resolution image sensors to detect motion of objects in the surrounding environment is typically constrained by the associated reduction in the sampling rate.

### SUMMARY

An electronic device that detects motion of one or more first objects is described. This electronic device includes a lens that conveys and focuses input electromagnetic waves. Moreover, the electronic device includes an optical component, optically coupled to the lens, that divides the input electromagnetic waves into a first subset of the input electromagnetic waves and a second subset of the input electromagnetic waves. Furthermore, the electronic device includes a first image sensor, optically coupled to the optical component, that receives the first subset of the input electromagnetic waves. Additionally, the electronic device includes a second image sensor, optically coupled to the optical component, that receives the second subset of the input electromagnetic waves, where the first image sensor has a lower resolution than the second image sensor, the first image sensor has a higher sampling rate than the second image sensor, and the first image sensor detects motion of the one or more first objects.

Note that the optical component may include: a beam splitter, one or more light pipes, and/or one or more optical fibers.

Moreover, the first image sensor or the second image sensor may include: a charge coupled device (CCD); and/or a complementary metal oxide semiconductor (CMOS) image sensor. Furthermore, the first image sensor may receive electromagnetic waves in a different band of frequencies than the second image sensor. Additionally, the first image sensor may include: photodiodes, photoresistors, and/or phototransistors.

In some embodiments, outputs from the first image sensor and the second image sensor may be synchronized.

Note that the first subset of the input electromagnetic waves and the second subset of the input electromagnetic waves may have a common field of view.

Moreover, the sampling rate of the first image sensor may be greater than or equal to 1,000 Hz. Furthermore, the resolution of the first image sensor may be less than or equal to 200×150.

Additionally, the electronic device may include a computation device that analyzes outputs of the first image sensor and the second image sensor. For example, the computation device may include: one or more processors, and/or one or more graphics processing units (GPU). In some embodiments, the analysis may use a pretrained neural network.

Note that the electronic device may dynamically set a threshold for motion detection based at least in part on an output of the first image sensor.

Moreover, the electronic device may analyze at least a portion of an output of the second image sensor based at least in part on an output of the first image sensor. For example, at least the portion of the output of the second image sensor may be affected by the motion detected by the first image sensor.

Furthermore, the one or more first objects in an output of the first image sensor may be guaranteed to match corresponding one or more second objects in an output of the second image sensor.

Additionally, the first image sensor may have a lower power consumption than the second image sensor.

In some embodiments, the electronic device may recommend a remedial action based at least in part on outputs of the first image sensor and the second image sensor.

Another embodiment provides a computer-readable storage medium for use with the electronic device. When executed by the electronic device, this computer-readable storage medium causes the electronic device to perform at least some of the aforementioned operations.

Another embodiment provides a method, which may be performed by the electronic device. This method includes at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of an electronic device in accordance with an embodiment of the present disclosure.

FIG. 2 is a block diagram illustrating an example of motion information acquired by a first image sensor in the electronic device of FIG. 1 in accordance with an embodiment of the present disclosure.

FIG. 3 is a block diagram of an example of a computer system in accordance with an embodiment of the present disclosure.

FIG. 4 is a flow diagram illustrating an example of a method for detecting motion of one or more first objects using an electronic device in FIG. 1 in accordance with an embodiment of the present disclosure.

FIG. 5 is a drawing illustrating an example of communication between components in the electronic device in FIG. 1 in accordance with an embodiment of the present disclosure.

FIG. 6 is a block diagram illustrating an example of a neural network in accordance with an embodiment of the present disclosure.

FIG. 7 is a block diagram illustrating an example of operations performed by blocks in a neural network in accordance with an embodiment of the present disclosure.

FIG. 8 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An electronic device may include a lens that conveys and focuses input electromagnetic waves. Moreover, the electronic device may include an optical component, optically coupled to the lens, that divides the input electromagnetic waves into a first subset of the input electromagnetic waves and a second subset of the input electromagnetic waves. Furthermore, the electronic device may include a first image sensor, optically coupled to the optical component, that receives the first subset of the input electromagnetic waves. Additionally, the electronic device may include a second image sensor, optically coupled to the optical component, that receives the second subset of the input electromagnetic waves, where the first image sensor has a lower resolution than the second image sensor, the first image sensor has a higher sampling rate than the second image sensor, and the first image sensor detects motion of one or more first objects.

By detecting motion using the first image sensor, which has a lower resolution and a higher sampling rate than the second image sensor, these imaging techniques may provide enhanced performance for the electronic device, without significantly increasing the cost, complexity and/or power consumption of the second image sensor and/or the electronic device. Notably, the first image sensor may be a low resolution, low power consumption image sensor that is operated at a high sampling rate. These capabilities of the first image sensor may allow the electronic device to have improved performance in detecting motion of the one or more first objects (e.g., in an environment surrounding the electronic device). Consequently, these capabilities may allow the electronic device to more effectively analyze an input to the second image sensor (e.g., based at least in part on an output from the first image sensor) and/or to recommend a remedial action based at least in part on outputs of the first image sensor and the second image sensor. Therefore, by improving the performance of the electronic device, the imaging techniques may enhance the user experience when using the electronic device.

In the discussion that follows, an image sensor (such as a CCD, a CMOS image sensor, etc.) and a lower resolution, higher sampling rate image sensor are used in conjunction to provide a cost-effective and reduced complexity electronic device for acquiring images and detecting motion in an environment. Notably, the use of a low resolution, high sampling rate image sensor may allow the electronic device to use existing components to detect motion. This approach may allow the electronic device to detect motion that existing imaging techniques cannot detect and to do so in a cost-effective manner. In addition, the power consumption of the electronic device may not be increased by these capabilities. Collectively, the imaging techniques may facilitate improved monitoring of the environment, without increasing cost, complexity and/or power consumption.

Moreover, while images are used as an illustration of the imaging techniques, more generally a wide variety of types of content may be used. Notably, the imaging techniques may be extended to include a first sensor for a type of content and a second sensor that detects changes in the type of content, where the second sensor has a lower resolution and a higher sampling rate than the first sensor. The type of content may include: audio, sound, acoustic data (such as ultrasound or seismic measurements), radar data, classifications, speech or speech-recognition data, object-recognition data, environmental data (such as data corresponding to temperature, humidity, barometric pressure, wind direction, wind speed, reflected sunlight, etc.), medical data (such as data from: computed tomography, magnetic resonance imaging, an electroencephalogram, an ultrasound, positron emission spectroscopy, an x-ray, electronic-medical records, etc.), cybersecurity data, law-enforcement data, legal data, criminal justice data, social network data, advertising data, supply-chain data, operations data, industrial data, employment data, human-resources data, education data, data generated using a generative adversarial network, simulated data, data associated with a database or data structure, and/or another type of data or information. However, in some embodiments, the type of content includes: images (such as an image in the visible spectrum, an infrared image, an ultraviolet image, an x-ray image, etc.), video, computer-vision data, etc. In the discussion that follows, images are used as illustrative examples of the content. In some embodiments, an image may be associated with a physical camera or image sensor. However, in other embodiments, an image may be associated with a ‘virtual camera’, such as an electronic device, computer or server that provides the image. Thus, the imaging techniques may be used to analyze images that have recently been acquired, to analyze images that are stored in the computer system and/or to analyze images received from one or more other electronic devices.

Furthermore, note that acquired images and/or motion information may be processed or analyzed using one or more pretrained neural networks. The one or more pretrained neural networks may include a wide variety of neural network architectures and configurations, including: a convolutional neural network, a recurrent neural network, an autoencoder neural network, a perceptron neural network, a feed forward neural network, a radial basis neural network, a deep feed forward neural network, a long/short term memory neural network, a gated recurrent unit neural network, a variational autoencoder neural network, a denoising neural network, a sparse neural network, a Markov chain neural network, a Hopfield neural network, a Boltzmann machine neural network, a restricted Boltzmann machine neural network, a deep belief neural network, a deep convolutional neural network, a deconvolutional neural network, a deep convolutional inverse graphics neural network, a generative adversarial neural network, a liquid state machine neural network, an extreme learning machine neural network, an echo state neural network, a deep residual neural network, a Kohonen neural network, a support vector machine neural network, a neural turing machine neural network, or another type of neural network (which may, at least, include: an input layer, one or more hidden layers, and an output layer).

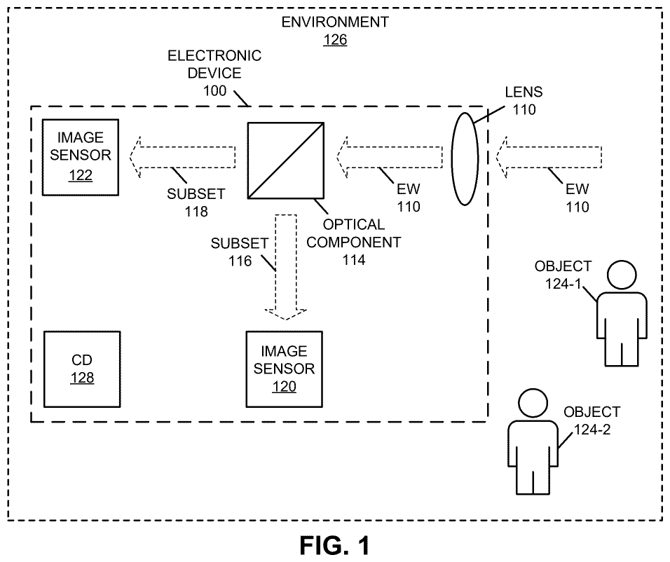

We now describe embodiments of the imaging techniques. FIG. 1 presents a block diagram illustrating an example of an electronic device 100 (such as a camera). Electronic device 100 may include an optional lens 112 that conveys and focuses input electromagnetic waves (EW) 110. Moreover, electronic device 100 may include an optical component 114, optically coupled to lens 112, that divides the input electromagnetic waves 110 into a subset 116 of the input electromagnetic waves and a subset 118 of the input electromagnetic waves. For example, optical component 112 may include: a beam splitter, one or more light pipes, and/or one or more optical fibers. Note that subset 116 of the input electromagnetic waves and subset 118 of the input electromagnetic waves may have a common field of view, which may eliminate alignment issues and a need for calibration of electronic device 100.

Furthermore, electronic device 100 may include an image sensor 120, optically coupled to optical component 114, that receives subset 116 of the input electromagnetic waves. Additionally, electronic device 100 may include an image sensor 122, optically coupled to optical component 114, that receives subset 118 of the input electromagnetic waves, where image sensor 120 has a lower resolution than image sensor 122, image sensor 120 has a higher sampling rate than image sensor 122 or optionally uses asynchronous read (such as when motion is detected), and image sensor 120 detects motion of one or more first objects 124 (such as one or more individuals) in an environment 126 that includes electronic device 100. In some embodiments, the one or more first objects 124 in an output of image sensor 120 may be guaranteed to match corresponding one or more second objects in an output of image sensor 122 (such as by using a common field of view for image sensor 120 and image sensor 122).

Image sensor 120 or image sensor 122 may include: a CCD; and/or a CMOS image sensor. Furthermore, image sensor 120 may receive electromagnetic waves in a different band of frequencies than image sensor 122. For example, depending on the application, image sensor 120 may perform measurements in the Infrared band of frequencies (or wavelengths between 800 nm and 1 mm), while image sensor 122 may perform measurements in the visible band of frequencies (such as wavelengths between 380 and 800 nm).

Additionally, image sensor 120 may track motion using larger pixels than image sensor 122. For example, image sensor 120 may include: photodiodes, photoresistors, and/or phototransistors. More generally, image sensor 120 may include a light-sensitive semiconductor component. In some embodiments, outputs from image sensor 120 and image sensor 122 may be synchronized. For example, the output of image sensor 122 (FIG. 1) may be tied to or synchronized with a buffer with the output of image sensor 120 (FIG. 1). Note that image sensor 120 may have a lower power consumption than image sensor 122. This capability may allow a gain of image sensor 120 to be increased (such as at low light intensity). In addition, the lower resolution of image sensor 120 may reduce a sensitivity to static electricity.

Moreover, the sampling rate of image sensor 120 may be greater than or equal to 1,000 Hz. Furthermore, the resolution of image sensor 120 may be less than or equal to 200×150 (e.g., 80×60).

Additionally, electronic device 100 may include a computation device (CD) 128 that analyzes outputs of image sensor 120 and image sensor 122. For example, computation device 128 may include: one or more processors, and/or one or more GPUs. In some embodiments, the analysis may use a pretrained neural network.

Note that electronic device 100 may dynamically set a threshold for motion detection based at least in part on an output of image sensor 120. Moreover, electronic device 100 may analyze at least a portion of an output of image sensor 122 based at least in part on an output of image sensor 120. For example, at least the portion of the output of image sensor 122 may be affected by the motion detected by image sensor 120. Furthermore, electronic device 100 may recommend a remedial action based at least in part on outputs of image sensor 120 and/or image sensor 122.

Notably, in existing image analysis, each frame may go through the analysis process in an attempt to identify motion and to match objects to the identified motion. However, because there is no guarantee that motion is detected, this approach is often difficult and expensive. In the disclosed imaging techniques, the object(s) that moved and their locations in environment 126 may be guaranteed to be detected. These capabilities may be used to accelerate the analysis of the images and to significantly reduce the associated complexity and power consumption (e.g., by a factor between 103 to 106).

In contrast with specialized and expensive motion-sensitive imaging technology, electronic device 100 may leverage existing technology to achieve superior performance with low cost, low complexity and low power consumption. Notably, image sensor 120 may be a low-cost component, while image sensor 122 may be usc existing image-sensor technology. Moreover, by using a higher sampling rate than image sensor 122 (e.g., 3000 fps, instead of 30 or 60 fps), electronic device 100 may be very sensitive to and able to acquire rich information about motion of the one or more first objects 124. However, because image sensor 122 has a lower resolution, the amount of information acquired when reading out image sensor 120 may be significantly reduced relative to image sensor 122, and the overall power consumption of electronic device 100 may not be appreciably increased. Note that the high frame rate when reading out image sensor 120 may ensure that the motion and the location of the motion in environment 126 of one of first objects 124 is accurately captured (including motion that may not be captured using a lower sampling rate).

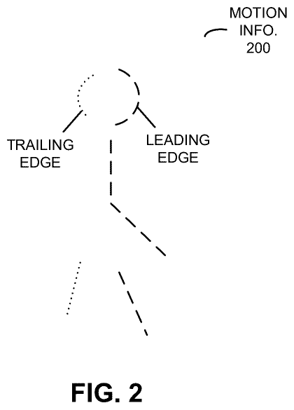

FIG. 2 presents a block diagram illustrating an example of motion information 200 acquired by image sensor 120 (FIG. 1) for an individual moving from left to right in the plane of FIG. 2. Because image sensor 120 (FIG. 1) is readback at a higher sampling rate, but has a lower resolution than image sensor 122 (FIG. 1), the motion information may be sensitive to the leading and trailing edges of a moving object in environment 126 (FIG. 1). This is shown in FIG. 2.

However, because the motion information acquired by electronic device 100 (FIG. 1) is modified relative to existing cameras and image sensors, neural networks that analyze the images acquired by image sensor 122 (FIG. 1) and the motion information 120 (FIG. 1) may need to be retrained. Nonetheless, and in contrast with specialized and expensive motion-sensitive imaging technology, the retaining may be relatively minor or limited. Consequently, the disclosed imaging techniques may be able to leverage existing neural networks to analyze the images and/or the motion information acquired by electronic device 100 (FIG. 1).

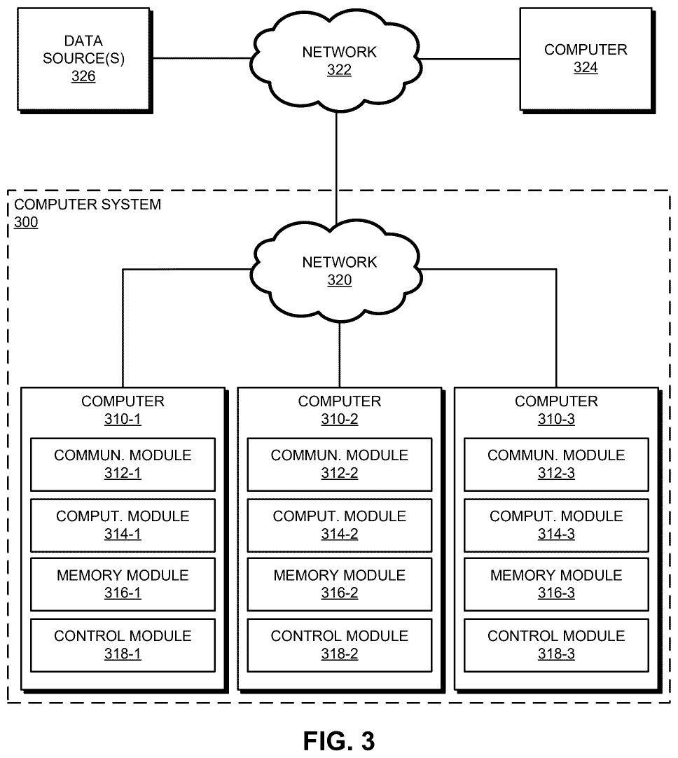

Thus, in some embodiments, the acquired image(s) and/or motion information may be analyzed, locally (e.g., on electronic device 100 in FIG. 1) and/or remotely, using one or more pretrained neural networks. For example, the acquired image(s) and/or motion information may be analyzed remotely using one or more pretrained neural networks that are implemented by a computer system. This is shown in FIG. 3, which presents a block diagram illustrating an example of a computer system 300. This computer system may include one or more computers 310. These computers may include: communication modules 312, computation modules 314, memory modules 316, and optional control modules 318. Note that a given module or engine may be implemented in hardware and/or in software.

Communication modules 312 may communicate frames or packets with data or information (such as training data or a training dataset, test data or a test dataset, control instructions, images or motion information) between computers 310 via a network 320 (such as the Internet and/or an intranet). For example, this communication may use a wired communication protocol, such as an Institute of Electrical and Electronics Engineers (IEEE) 802.3 standard (which is sometimes referred to as ‘Ethernet’) and/or another type of wired interface. Alternatively or additionally, communication modules 312 may communicate the data or the information using a wireless communication protocol, such as: an IEEE 802.11 standard (which is sometimes referred to as ‘Wi-Fi’, from the Wi-Fi Alliance of Austin, Texas), Bluetooth (from the Bluetooth Special Interest Group of Kirkland, Washington), a third generation or 3G communication protocol, a fourth generation or 4G communication protocol, e.g., Long Term Evolution or LTE (from the 3rd Generation Partnership Project of Sophia Antipolis, Valbonne, France), LTE Advanced (LTE-A), a fifth generation or 5G communication protocol, other present or future developed advanced cellular communication protocol, or another type of wireless interface. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies.

In the described embodiments, processing a packet or a frame in a given one of computers 310 (such as computer 310-1) may include: receiving the signals with a packet or the frame; decoding/extracting the packet or the frame from the received signals to acquire the packet or the frame; and processing the packet or the frame to determine information contained in the payload of the packet or the frame. Note that the communication in FIG. 3 may be characterized by a variety of performance metrics, such as: a data rate for successful communication (which is sometimes referred to as ‘throughput’), an error rate (such as a retry or resend rate), a mean squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). Note that wireless communication between components in FIG. 3 uses one or more bands of frequencies, such as: 900 MHZ, 2.4 GHz, 5 GHZ, 6 GHz, 60 GHz, the Citizens Broadband Radio Spectrum or CBRS (e.g., a frequency band near 3.5 GHZ), and/or a band of frequencies used by LTE or another cellular-telephone communication protocol or a data communication protocol. In some embodiments, the communication between the components may use multi-user transmission (such as orthogonal frequency division multiple access or OFDMA) and/or multiple input multiple output (MIMO).

Moreover, computation modules 314 may perform calculations using: one or more microprocessors, ASICs, microcontrollers, programmable-logic devices, GPUs and/or one or more digital signal processors (DSPs). Note that a given computation component is sometimes referred to as a ‘computation device’.

Furthermore, memory modules 316 may access stored data or information in memory that is local in computer system 300 and/or that is remotely located from computer system 300. Notably, in some embodiments, one or more of memory modules 316 may access stored training data, test data, images and/or motion information in the local memory. Alternatively or additionally, in other embodiments, one or more memory modules 316 may access, via one or more of communication modules 312, stored training data, test data, images and/or motion information in the remote memory in computer 324, e.g., via network 320 and network 322. Note that network 322 may include: the Internet and/or an intranet. In some embodiments, the training data and/or the test data may include data, images or motion information that are received from one or more data sources 326 (such as electronic device 100 in FIG. 1) via network 320 and network 322 and one or more of communication modules 312. Thus, in some embodiments at least some of the training data, the test data, images and/or motion information may have been received previously and may be stored in memory, while in other embodiments at least some of the training data, the test data, images and/or motion information may be received in real time from the one or more data sources 326 (e.g., as the training of the neural network is performed or while analysis is performed by a pretrained neural network).

While FIG. 3 illustrates computer system 300 at a particular location, in other embodiments at least a portion of computer system 300 is implemented at more than one location. Thus, in some embodiments, computer system 300 is implemented in a centralized manner, while in other embodiments at least a portion of computer system 300 is implemented in a distributed manner. For example, in some embodiments, the one or more data sources 326 may include local hardware and/or software that performs at least some of the operations in the imaging techniques. This remote processing may reduce the amount of training data, the test data, images and/or motion information that is communicated via network 320 and network 322. In addition, the remote processing may anonymize the data that are communicated to and analyzed by computer system 300. This capability may help ensure computer system 300 is secure and maintains privacy of individuals, who may be associated with the training data and/or the test data. For example, computer system 300 may be compatible and compliant with regulations, such as the Health Insurance Portability and Accountability Act, e.g., by removing or obfuscating protected health information in the data.

Although we describe the computation environment shown in FIG. 3 as an example, in alternative embodiments, different numbers or types of components may be present in computer system 300. For example, some embodiments may include more or fewer components, a different component, and/or components may be combined into a single component, and/or a single component may be divided into two or more components. Alternatively or additionally, in some embodiments, some or all of the operations in the imaging techniques may be performed by an electronic device, such as a cellular telephone, a tablet, a computer, etc.

During the imaging techniques, one or more of optional control modules 318 may divide the training of the neural network among computers 310. For example, the one or more of optional control modules 318 may identify or obtain content (such as images and/or motion information) from one or more of data sources 326 and/or in local and/or remote memory using one or more of memory modules 316. Alternatively, the one or more of optional control modules 318 may generate the content (e.g., using another pretrained neural network).

Then, a given computer (such as computer 310-1) may perform at least a designated portion of the training of the neural network. Notably, computation module 314-1 may receive or access training data that includes content (such as images and/or motion information), an architecture or configuration of the neural network (including a number of layers, a number of synapses, relationships or interconnections between synapses, activations functions, and/or weights), and a set of one or more hyperparameters governing at least the initial training of the neural network (such as a type or variation of stochastic gradient descent, a type of gradient, a learning rate or step size, e.g., 0.01, for the weights in a given layer in the neural network, a loss function, a regularizing term in a loss function, etc.). For example, the neural network may include a feedforward neural network with multiple layers. Each of the layers include one or more synapses. A given synapse may have associated weights and one or more activation functions (such as a rectified linear activation function or ReLU, ReLU6 in which the rectified linear activation function is modified to have a maximum size or value, a leaky ReLU, an exponential linear unit or ELU activation function, a parametric ReLU, a tanh activation function, or a sigmoid activation function) for each input to the given synapse. In general, the output of a given synapse of layer i may be fed as input into one or more synapse in layer i+1. Based at least in part on the information, computation module 314-1 may implement some or all of the neural network.

Next, computation module 314-1 may perform the training of the neural network, which may involve iteratively computing values of the weights associated with the synapses in the neural network during iterations or cycles of the training. For example, the training may initially use a type or variation of stochastic gradient descent and a loss function of an L1 norm (or least absolute deviation) or an L2 norm (or least square error) of the training error (the difference of an output of the neural network with a known output in the training data). Note that a loss (or cost) landscape may be defined as values of the loss function for different weights associated with the synapses in the neural network. A given location in the loss landscape may correspond to particular values of the weights.

During the training of the neural network, the weights may evolve or change as the neural network traverses the loss landscape (a process that is sometimes referred to as ‘learning’). For example, the weights may be updated after one or more iteration or cycles of the training process, which, in some embodiments, may include updates to the weights in each iteration or cycle. Note that the training may continue until a convergence criterion is achieved, such as a training error of approximately zero, a validation error of approximately zero and/or a timeout of the training of the neural network (such as a maximum training time of 5-10 days).

Moreover, after completing the training of the neural network (including evaluation using the test data and/or validation data), control module 318-1 may store results of the training of the neural network (e.g., the weights, the training error, the test error, etc.) in local and/or remote memory using memory module 316-1. Alternatively or additionally, control module 318-1 may instruct communication module 314-1 to communicate results of the training of the neural network with other computers 310 in computer system 300 or with computers (not shown) external to computer system 300. This may allow the results from different computers 310 to be aggregated. In some embodiments, control module 318-1 may display at least a portion of the results, e.g., to an operator of computer system 300, so that the operator can evaluate the training of the neural network.

Furthermore, control module 318-1 may instruct computation module 314-1 to implement the pretrained neural network. Then, control module 318-1 may instruct computation module 314-1 to analyze one or more images and/or motion information received from one or more data sources 326 using the pretrained neural network. In some embodiments, computation module 314-1 may determine and then may provide, via communication module 312-1, a recommendation for a remedial action based at least in part on analysis of one or more images and/or motion information acquired by electronic device 100 (FIG. 1).

In these ways, computer system 300 may improve the training and/or the performance of the neural network. For example, the imaging techniques may enable the neural network to be trained using standard tools (such as existing neural network architectures) and training datasets, and to achieve improved performance when analyzing images and/or motion information acquired by, e.g., electronic device 100 (FIG. 1). Notably, the neural network may have improved quality and accuracy, so that the trained neural network generalizes well to the test data and/or the validation data, and accurately analyzed the images and/or motion information.

In some embodiments, the pretrained neural network may include intentionally added predefined bias that implements augmentation and/or suppression of one or more synapses in the pretrained neural network. For example, the activation and/or suppression may adjust weights associated with the one or more synapses for a predefined time interval.

Note that in some embodiments the type of intentionally added predefined bias may match the nature of the neural network and its input data. For image classifier neural networks, the intentionally added predefined bias may be placed anywhere in an input image provided that it will not be stretched or cropped beyond recognition. For example, the intentionally added predefined bias may include a distinctly colored square of 4 pixels-by-4 pixels in the upper left corner of the input image. Alternatively, the entire bottom row of pixels may be changed to a single color or the alpha channel may be changed for those pixels to 0.5. However, these types of intentionally added predefined bias may not work well with an object-detection neural network. That is because object detectors (such as MobileNetv2 Single-Shot Detector or SSD from Alphabet Inc. of Mountain View, California, or You Only Look Once, Version 3 or YOLOv3 from the University of Washington of Seattle, Washington) typically do not use the entire image when performing the object-recognition processing operation. For object detectors, the intentionally added predefined bias may be something that alters the entire image equally. For example, the intentionally added predefined bias may include overlaying a green (or colored) square every 20 pixels in an alternating repeating pattern like a checkerboard across the entire image. Using this approach, every section of the image may have a detectable the intentionally added predefined bias. Using an intentionally added predefined bias that alters the entire image may be suitable for multiple types of neural networks, so it may be a good default choice.

More generally, the type of intentionally added predefined bias may be selected based at least in part on a type of processing performed in a particular neural network, such as the processing performed in a particular layer of a neural network. Moreover, the disclosed imaging techniques may be used with a wide variety of neural networks, including neural networks that are used with input images, neural networks that are used with audio input, etc.

Note that the pretrained neural network may be able to correctly interpret the motion information provided by image sensor 120 in electronic device 100 (FIG. 1).

These capabilities may improve the performance of computer system 300 when analyzing and/or interpreting images and/or motion information from electronic device 100 in FIG. 1 and, more generally, one of data sources 326. The improved performance may allow computer system 300 to make better recommendations and/or to perform more appropriate remedial action based at least in part on images and/or motion information from electronic device 100 in FIG. 1. Consequently, the imaging techniques may improve the user experience when using electronic device 100 (FIG. 1) and/or computer system 300, e.g., in sensitive applications (such as healthcare, law enforcement, etc.).

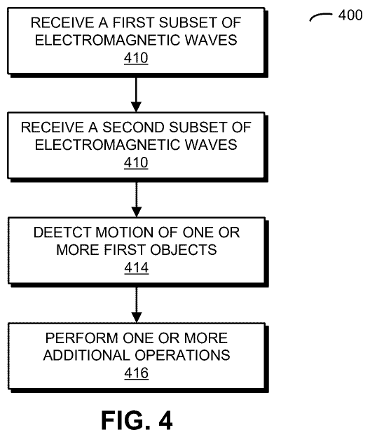

We now describe embodiments of the method. FIG. 4 presents a flow diagram illustrating an example of a method 400 for detecting motion of one or more first objects, which may be performed by an electronic device (such as electronic device 100 in FIG. 1). During operation, the electronic device may receive a first subset of input electromagnetic waves (operation 410) using a first image sensor. Moreover, the electronic device may receive a second subset of input electromagnetic waves (operation 412) using a second image sensor, where the first image sensor and the second image sensor have a common field of view. Then, the electronic device may detect the motion of the one or more first objects (operation 414) based at least in part on an output of the first image sensor, where the first image sensor has a lower resolution than the second image sensor, and the first image sensor has a higher sampling rate than the second image sensor.

Note that the first image sensor or the second image sensor may include: a CCD; and/or a CMOS image sensor. Furthermore, the first image sensor may receive electromagnetic waves in a different band of frequencies than the second image sensor. Additionally, the first image sensor may include: photodiodes, photoresistors, and/or phototransistors.

In some embodiments, outputs from the first image sensor and the second image sensor may be synchronized.

Moreover, the sampling rate of the first image sensor may be greater than or equal to 1,000 Hz. Furthermore, the resolution of the first image sensor may be less than or equal to 200×150.

Additionally, the first image sensor may have a lower power consumption than the second image sensor.

In some embodiments, the electronic device may optionally perform one or more additional operations (operation 416). For example, the electronic device may analyze outputs of the first image sensor and the second image sensor. Notably. the computation device may include: one or more processors, and/or one or more GPUs. Moreover, the analysis may use a pretrained neural network.

Note that the electronic device may dynamically set a threshold for motion detection based at least in part on an output of the first image sensor. For example, the threshold may correspond to changes in values of pixels associated with motion at a leading edge and/or a training edge of an object.

Furthermore, the electronic device may analyze at least a portion of an output of the second image sensor based at least in part on an output of the first image sensor. For example, at least the portion of the output of the second image sensor may be affected by the motion detected by the first image sensor.

Additionally, the one or more first objects in an output of the first image sensor may be guaranteed to match corresponding one or more second objects in an output of the second image sensor.

In some embodiments, the electronic device may recommend a remedial action based at least in part on outputs of the first image sensor and the second image sensor. For example, the remedial action may include: providing a notification to an owner of a property, calling law enforcement when an intruder is detected, etc.

In some embodiments of method 400, there may be additional or fewer operations. Furthermore, the order of the operations may be changed, and/or two or more operations may be combined into a single operation.

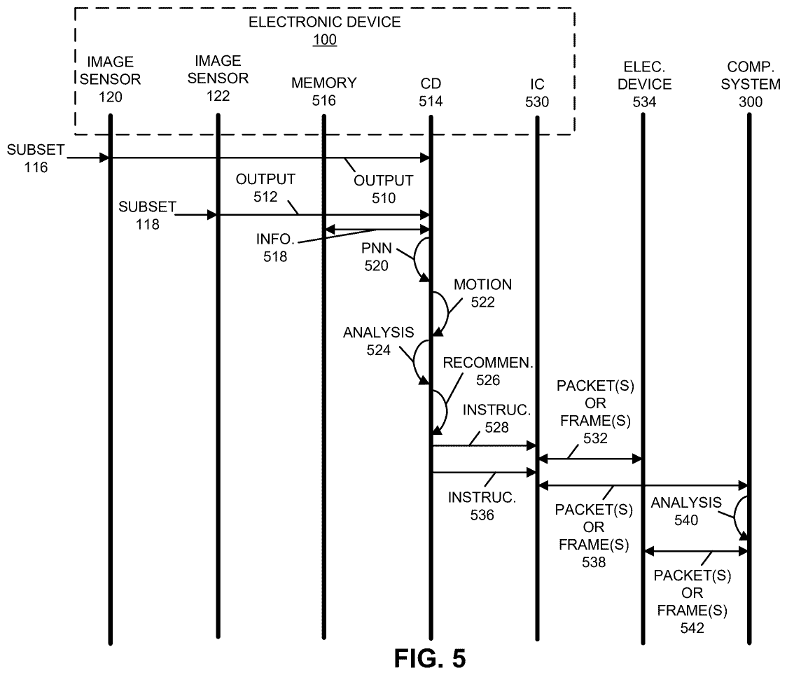

Embodiments of the imaging techniques are further illustrated in FIG. 5, which presents a drawing illustrating an example of communication among components in electronic device 100. In FIG. 5, image sensor 120 in electronic device 100 receives subset 116 (FIG. 1) of input electromagnetic waves and provides corresponding output 510, and image sensor 122 in electronic device 100 receives subset 118 (FIG. 1) of input electromagnetic waves and provides corresponding output 512. Note that image sensor 120 and image sensor 122 may have a common field of view, image sensor 120 may have a lower resolution than image sensor 122, and image sensor 120 may have a higher sampling rate than image sensor 122.

A computation device (CD) 514 (such as a processor or a GPU) in electronic device 100 may access, in memory 516 in electronic device 100, information 518 specifying a pretrained neural network (PNN) 520, such as an architecture or a configuration of pretrained neural network 520. Based at least in part on information 518, computation device 514 may implement pretrained neural network 520.

Then, computation device 514 (e.g., using pretrained neural network 520) may detect motion 522 of the one or more first objects 124 (FIG. 1) based at least in part on output 510. Moreover, computation device 514 may analyze 524 output 512, e.g., based at least in part on detected motion 522. In some embodiments, computation device 514 may determine a recommendation 526 for a remedial action based at least in part on analysis 524. Then, computation device 514 may instruct 528 interface circuit 530 in electronic device 100 to provide one or more packets or frames 532 with results of analysis 524 and/or recommendation 526 to electronic device 534, such as a cellular telephone or a computer associated with a user of electronic device 100.

Alternatively or additionally, in some embodiments, the analysis of output 510 and output 512 may be performed by computer system 300. Notably, computation device 514 may instruct 536 interface circuit 530 to provide information 538 specifying output 510 and output 512 (such as one or more frames) to computer system 300.

After receiving information 538, a computational device (such as a processor or a GPU) in computer system 300, which implements pretrained neural network 520, may analyze 540 information 538. For example, analysis 540 may include results and/or a recommendation for a remedial action.

Subsequently, the computation device may store the results and/or the recommendation in memory in or associated with computer system 300. Alternatively or additionally, the computation device may instruct an interface circuit in computer system 300 to provide one or more packets or frames 542 with the results and/or the recommendation to electronic device 534.

While FIG. 5 illustrate communication between components using unidirectional or bidirectional communication with lines having single arrows or double arrows, in general the communication in a given operation in these figures may involve unidirectional or bidirectional communication. Moreover, at least some of the operations in FIG. 5 may be performed sequentially or in parallel.

We now further describe embodiments of the imaging techniques. Electronic device 100 (FIG. 1) may include two different image sensors (or cameras) with different resolutions and frame rates (or sampling rates). This approach may guarantee that motion and its location in an environment is detected. This capability may allow subsequent analysis or processing of images of the environment to be focused on the location where motion occurred or is occurring. Moreover, the different frame rates may allow the image(s) to be distributed for processing.

The disclosed imaging techniques may address the problem of object permanence using low-cost hardware. Note that even when there is motion within a pixel associated with image sensor 120 (FIG. 1), there may be a measurable change in the measured luminosity or brightness. Consequently, an associated threshold may be dynamically set or determined during image processing. This capability may provide automatic adaptation to filter the image(s) and motion information based at least in part on the speed of the motion of one or more objects in the environment.

Moreover, the disclosed imaging techniques may allow the analysis of a given image to be focused on the relevant subsets of objects (or portion(s) of the given image that is affected by motion (e.g., the path or trajectory of a bullet). This may result in significant improvement in the processing and resource utilization (such as a significant reduction in power consumption).

The disclosed imaging techniques may allow motion to be detected separately from image acquisition. Consequently, motion detection may be separated from object detection (as is the case in human perception). Consequently, a neural network used to analyze the image(s) and motion information may be trained to react to stimuli. However, there may not need to be any other changes in the image processing. Moreover, frames may be dropped (e.g., in software) in the analysis of the images by a pretrained neural network. In addition, the motion information may be concurrently analyzed using multiple different analysis techniques, so that the best or most-suitable analysis technique is used for a particular set of circumstances.

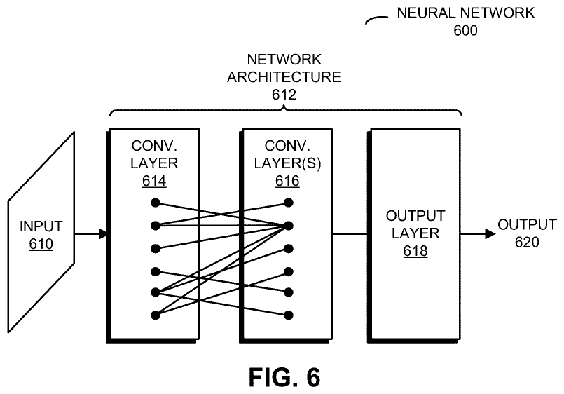

We now describe an exemplary embodiment of a neural network. FIG. 6 presents a block diagram illustrating an example of a neural network 600. Notably, neural network 600 may be implemented using a convolutional neural network. This neural network may include a network architecture 612 that includes: an initial convolutional layer 614 that provides filtering of input 610 (such as one or more images and/or motion information); one or more additional convolutional layer(s) 616 that apply weights; and an output layer 618 (such as a rectified linear layer) that performs classification (e.g., distinguishing a dog from a cat) and provides output 620. Note that the details with the different layers in neural network 600, as well as their interconnections, may define network architecture 612 (such as a directed acyclic graph). These details may be specified by the instructions for neural network 600. In some embodiments, neural network 600 may be reformulated as a series of matrix multiplication operations.

Note that neural network 600 may be used to analyze an image or a sequence of images (such as video acquired by image sensor 122 (FIG. 1) at a frame rate of, e.g., 30 or 60 frames/s) and/or motion information acquired by image sensor 120 (FIG. 1).

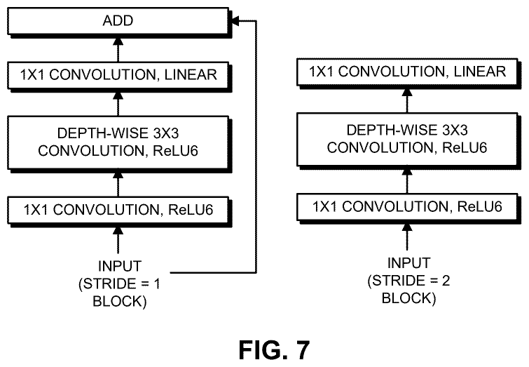

In some embodiments, the neural network may have a similar architecture to MobileNetv2 SSD. For example, the neural network may be a convolutional neural network with 53 layers. The block implemented in these layers are shown in FIG. 7, which presents a block diagram of the operations performed by blocks (or layers) in the neural network. Note that operations may include a pipeline with operations such as: 1×1 convolution using a ReLU6 activation function, a 1×1 convolution using a linear activation function, and a depth-wise 3×3 convolution using a ReLU6 activation function. In some embodiments, the disclosed imaging techniques may use: Keras (from Alphabet, Inc. of Mountain View, California), TensorFlow (from Alphabet Inc. of Mountain View, California), PyTorch (from Meta of Menlo Park, California) and/or Scikit-Learn (from the French Institute for Research in Computer Science and Automation in Scalay, France). Moreover, the training data used to train the neural network may include ImageNet (from Stanford University of Stanford, California, and Princeton University of Princeton, New Jersey).

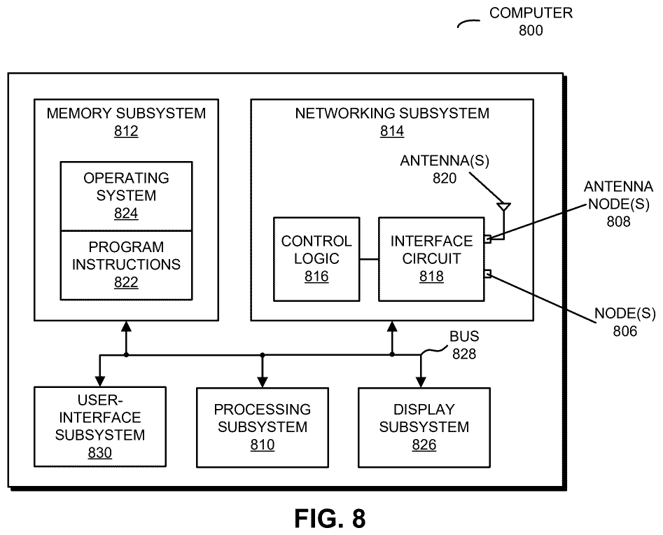

We now describe embodiments of an electronic device, which may perform at least some of the operations in the imaging techniques. FIG. 8 presents a block diagram illustrating an example of an electronic device 800 (such as electronic device 100 in FIG. 1), in accordance with some embodiments. This electronic device may include processing subsystem 810, memory subsystem 812, and networking subsystem 814. Processing subsystem 810 includes one or more devices configured to perform computational operations. For example, processing subsystem 810 can include one or more microprocessors, ASICs, microcontrollers, programmable-logic devices, GPUs and/or one or more DSPs. Note that a given component in processing subsystem 810 are sometimes referred to as a ‘computation device’.

Memory subsystem 812 includes one or more devices for storing data and/or instructions for processing subsystem 810 and networking subsystem 814. For example, memory subsystem 812 can include dynamic random access memory (DRAM), static random access memory (SRAM), and/or other types of memory. In some embodiments, instructions for processing subsystem 810 in memory subsystem 812 include: program instructions or sets of instructions (such as program instructions 822 or operating system 824), which may be executed by processing subsystem 810. Note that the one or more computer programs or program instructions may constitute a computer-program mechanism. Moreover, instructions in the various program instructions in memory subsystem 812 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 810.

In addition, memory subsystem 812 can include mechanisms for controlling access to the memory. In some embodiments, memory subsystem 812 includes a memory hierarchy that comprises one or more caches coupled to a memory in electronic device 800. In some of these embodiments, one or more of the caches is located in processing subsystem 810.

In some embodiments, memory subsystem 812 is coupled to one or more high-capacity mass-storage devices (not shown). For example, memory subsystem 812 can be coupled to a magnetic or optical drive, a solid-state drive, or another type of mass-storage device. In these embodiments, memory subsystem 812 can be used by electronic device 800 as fast-access storage for often-used data, while the mass-storage device is used to store less frequently used data.

Networking subsystem 814 includes one or more devices configured to couple to and communicate on a wired and/or wireless network (i.e., to perform network operations), including: control logic 816, an interface circuit 818 and one or more antennas 820 (or antenna elements). (While FIG. 8 includes one or more antennas 820, in some embodiments electronic device 800 includes one or more nodes, such as antenna nodes 808, e.g., a metal pad or a connector, which can be coupled to the one or more antennas 820, or nodes 806, which can be coupled to a wired or optical connection or link. Thus, electronic device 800 may or may not include the one or more antennas 820. Note that the one or more nodes 806 and/or antenna nodes 808 may constitute input(s) to and/or output(s) from electronic device 800.) For example, networking subsystem 814 can include a Bluetooth™ networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi® networking system), an Ethernet networking system, and/or another networking system.

Networking subsystem processors, controllers, 814 includes radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 800 may use the mechanisms in networking subsystem 814 for performing simple wireless communication between electronic devices, e.g., transmitting advertising or beacon frames and/or scanning for advertising frames transmitted by other electronic devices.

Within electronic device 800, processing subsystem 810, memory subsystem 812, and networking subsystem 814 are coupled together using bus 828. Bus 828 may include an electrical, optical, and/or electro-optical connection that the subsystems can use to communicate commands and data among one another. Although only one bus 828 is shown for clarity, different embodiments can include a different number or configuration of electrical, optical, and/or electro-optical connections among the subsystems.

In some embodiments, electronic device 800 includes a display subsystem 826 for displaying information on a display, which may include a display driver and the display, such as a liquid-crystal display, a multi-touch touchscreen, etc. Moreover, electronic device 800 may include a user-interface subsystem 830, such as: a mouse, a keyboard, a trackpad, a stylus, a voice-recognition interface, and/or another human-machine interface.

Electronic device 800 can be (or can be included in) any electronic device with at least one network interface. For example, electronic device 800 can be (or can be included in): a desktop computer, a laptop computer, a subnotebook/netbook, a server, a supercomputer, a tablet computer, a smartphone, a cellular telephone, a consumer-electronic device, a portable computing device, communication equipment, and/or another electronic device.

Although specific components are used to describe electronic device 800, in alternative embodiments, different components and/or subsystems may be present in electronic device 800. For example, electronic device 800 may include one or more additional processing subsystems, memory subsystems, networking subsystems, and/or display subsystems. Additionally, one or more of the subsystems may not be present in electronic device 800. Moreover, in some embodiments, electronic device 800 may include one or more additional subsystems that are not shown in FIG. 8. Also, although separate subsystems are shown in FIG. 8, in some embodiments some or all of a given subsystem or component can be integrated into one or more of the other subsystems or component(s) in electronic device 800. For example, in some embodiments program instructions 822 are included in operating system 824 and/or control logic 816 is included in interface circuit 818.

Moreover, the circuits and components in electronic device 800 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit may implement some or all of the functionality of networking subsystem 814 and/or electronic device 800. The integrated circuit may include hardware and/or software mechanisms that are used for transmitting signals from electronic device 800 and receiving signals at electronic device 800 from other electronic devices. Aside from the mechanisms herein described, radios are generally known in the art and hence are not described in detail. In general, networking subsystem 814 and/or the integrated circuit may include one or more radios.

In some embodiments, an output of a process for designing the integrated circuit, or a portion of the integrated circuit, which includes one or more of the circuits described herein may be a computer-readable medium such as, for example, a magnetic tape or an optical or magnetic disk or solid state disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the imaging techniques may be implemented using program instructions 822, operating system 824 (such as a driver for interface circuit 818) or in firmware in interface circuit 818. Thus, the imaging techniques may be implemented at runtime of program instructions 822. Alternatively or additionally, at least some of the operations in the imaging techniques may be implemented in a physical layer, such as hardware in interface circuit 818.

In the preceding description, we refer to ‘some embodiments’. Note that ‘some embodiments’ describes a subset of all of the possible embodiments, but does not always specify the same subset of embodiments. Moreover, note that the numerical values provided are intended as illustrations of the imaging techniques. In other embodiments, the numerical values can be modified or changed.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
a lens configured to convey and focus input electromagnetic waves;
an optical component, optically coupled to the lens, configured to divide the input electromagnetic waves into a first subset of the input electromagnetic waves and a second subset of the input electromagnetic waves;
a first image sensor, optically coupled to the optical component, configured to receive the first subset of the input electromagnetic waves; and
a second image sensor, optically coupled to the optical component, configured to receive the second subset of the input electromagnetic waves, wherein the first image sensor has a lower resolution than the second image sensor, the first image sensor has a higher sampling rate than the second image sensor, and the first image sensor is configured to detect motion of one or more first objects.

2. The electronic device of claim 1, wherein the optical component comprises: a beam splitter, one or more light pipes, or one or more optical fibers.

3. The electronic device of claim 1, wherein the first image sensor or the second image sensor comprise: a charge coupled device (CCD); or a complementary metal oxide semiconductor (CMOS) image sensor.

4. The electronic device of claim 1, wherein the first image sensor is configured to receive electromagnetic waves in a different band of frequencies than the second image sensor.

5. The electronic device of claim 1, wherein the first image sensor comprises: photodiodes, photoresistors, or phototransistors.

6. The electronic device of claim 1, wherein outputs from the first image sensor and the second image sensor are synchronized.

7. The electronic device of claim 1, wherein the first subset of the input electromagnetic waves and the second subset of the input electromagnetic waves have a common field of view.

8. The electronic device of claim 1, wherein the sampling rate of the first image sensor is greater than or equal to 1,000 Hz.

9. The electronic device of claim 1, wherein the resolution of the first image sensor is less than or equal to 200×150.

10. The electronic device of claim 1, wherein the electronic device comprises a computation device that analyzes outputs of the first image sensor and the second image sensor.

11. The electronic device of claim 10, wherein the computation device comprises:
a processor, or a graphics processing unit (GPU).

12. The electronic device of claim 10, wherein the analysis uses a pretrained neural network.

13. The electronic device of claim 1, wherein the electronic device is configured to dynamically set a threshold for motion detection based at least in part on an output of the first image sensor.

14. The electronic device of claim 1, wherein the electronic device is configured to analyze at least a portion of an output of the second image sensor based at least in part on an output of the first image sensor.

15. The electronic device of claim 14, wherein at least the portion of the output of the second image sensor is affected by the motion detected by the first image sensor.

16. The electronic device of claim 1, wherein the one or more first objects in an output of the first image sensor are guaranteed to match corresponding one or more second objects in an output of the second image sensor.

17. The electronic device of claim 1, wherein the first image sensor has a lower power consumption than the second image sensor.

18. The electronic device of claim 1, wherein the electronic device is configured to recommend a remedial action based at least in part on outputs of the first image sensor and the second image sensor.

19. A method of detecting motion of one or more first objects, comprising:
by an electronic device:
receiving a first subset of input electromagnetic waves using a first image sensor;
receiving a second subset of input electromagnetic waves using a second image sensor, wherein the first image sensor and the second image sensor have a common field of view; and
detecting the motion of the one or more first objects based at least in part on an output of the first image sensor, wherein the first image sensor has a lower resolution than the second image sensor, and the first image sensor has a higher sampling rate than the second image sensor.

20. A non-transitory computer-readable storage medium for use in conjunction with an electronic device, the computer-readable storage medium configured to store program instructions that, when executed by the electronic device, causes the electronic device to perform operations comprising:
receiving a first subset of input electromagnetic waves using a first image sensor;
receiving a second subset of input electromagnetic waves using a second image sensor, wherein the first image sensor and the second image sensor have a common field of view; and
detecting motion of the one or more first objects based at least in part on an output of the first image sensor, wherein the first image sensor has a lower resolution than the second image sensor, and the first image sensor has a higher sampling rate than the second image sensor.
